(19) United States
(12) Patent Application Publication
(10) Pub. No.: US 2008/0040466 A1
(43) Pub. Date: Feb. 14, 2008

(54) System and method for object-oriented meta-data driven instrumentation

(75) Inventors: Arieh Markel, Broomfield, CO (US); Jordan Thomas Boucher, Broomfield, CO (US); Peter H. Schow, Longmont, CO (US); Brandon Eugene Taylor, Longmont, CO (US)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/473,099

(22) Filed: Jun. 22, 2006

(51) Int. Cl. G06F 15/173

(52) U.S. Cl. 709/223

(57) ABSTRACT

A method for managing an asset includes identifying an asset type of the asset, identifying a plurality of categories of the asset type, assembling a plurality of primitive definitions into a native asset interface definition according to the plurality of categories, where the plurality of primitive definitions are stored in a library, where the native asset interface definition is bound to a data acquisition (DAQ) definition, and where the DAQ definition is an interface between a protocol handler and an information model, and adding the native asset interface definition to a DAQ runtime, where the DAQ runtime uses the DAQ definition to manage the asset.

### CROSS-REFERENCE TO RELATED APPLICATIONS

The present application contains subject matter that may be related to the subject matter in the following U.S. patent applications, which are all assigned to a common assignee: “System and Method for Meta-data Driven Instrumentation” (Attorney Docket No. 03226/810001; SUN060471) filed on Jun. 22, 2006; “System and Method for Meta-data Driven Instrumentation” (Attorney Docket No. 03226/811001; SUN060472) filed on Jun. 22, 2006; “Resource Discovery and Enumeration in the Meta-Data Driven Instrumentation” (Attorney Docket No. 03226/812001; SUN060473) filed on Jun. 22, 2006; “System and Method for Native-Asset-Interface Libraries for Instrumentation” (Attorney Docket No. 03226/814001; SUN060475) filed on Jun. 22, 2006; “Asynchronous Events in Meta-Data Driven Instrumentation” (Attorney Docket No. 03226/815001; SUN060476) filed on Jun. 22, 2006; “System and Method for Efficient Meta-Data Driven Instrumentation” (Attorney Docket No. 03226/816001; SUN060477) filed on Jun. 22, 2006; and “System and Method for Mapping between Instrumentation and Information Model” (Attorney Docket No. 03226/817001; SUN060478) filed on Jun. 22, 2006.

### BACKGROUND

A network corresponds to an interconnection of more than one computer system. For example, one type of network is a home network. A home network may correspond to two or more personal computers that can exchange data with each other and the Internet. Different types of networks exist throughout society. For example, large organizations often have data centers, servers, and various personal computer systems to exchange information between users, and to provide processing power to a single user.

In order to provide such functionality, a network includes various types of hardware and software. For example, the hardware includes the computer systems (personal computers, servers, and other such computing devices), network interface hardware, interconnection mediums (e.g., cables, wireless signals, etc.) routers, switches, hubs, and other such hardware. The software is instructions for providing the functionality of the network. For example, the software may include operating systems, network specific applications, user applications, server applications, etc.

In order to keep a network operating properly, the network must be managed. Managing a network involves managing the different resources (i.e., hardware and software) of the network. Typically, a resource can be managed through an application programming interface (API) of the resource. An application programming interface is the interface that a resource provides in order to allow management requests for service and management data to be made of the resource by management applications. Specifically, a management application that has knowledge of the application programming interface of the resource can manage the resource by accessing the different functions and data available through the application programming interface of the resource.

### SUMMARY

In general, in one aspect, the invention relates to a method for managing an asset. The method includes identifying an asset type of the asset, identifying a plurality of categories of the asset type, assembling a plurality of primitive definitions into a native asset interface definition according to the plurality of categories, wherein the plurality of primitive definitions are stored in a library, wherein the native asset interface definition is bound to a data acquisition (DAQ) definition, and wherein the DAQ definition is an interface between a protocol handler and an information model, and adding the native asset interface definition to a DAQ runtime, wherein the DAQ runtime uses the DAQ definition to manage the asset.

In general, in one aspect, the invention relates to a system for managing an asset. The system includes a library for storing a plurality of primitive definitions, and a developer environment for identifying an asset type of the asset, identifying a plurality of categories of the asset type, assembling a plurality of primitive definitions into a native asset interface definition according to the plurality of categories, wherein the plurality of primitive definitions are stored in a library, wherein the native asset interface definition is bound to a data acquisition (DAQ) definition, and wherein the DAQ definition is an interface between a protocol handler and an information model, and adding the native asset interface definition to a DAQ runtime, wherein the DAQ runtime uses the DAQ definition to manage the asset.

In general, in one aspect, the invention relates to a computer usable medium. The invention includes computer readable program code embodied therein for causing a computer system to identify an asset type of an asset, identify a plurality of categories of the asset type, assemble a plurality of primitive definitions into a native asset interface definition according to the plurality of categories, wherein the plurality of primitive definitions are stored in a library, wherein the native asset interface definition is bound to a data acquisition (DAQ) definition, and wherein the DAQ definition is an interface between a protocol handler and an information model, and add the native asset interface definition to a DAQ runtime, wherein the DAQ runtime uses the DAQ definition to manage the asset.

Other aspects of the invention will be apparent from the following description and the appended claims.

### BRIEF DESCRIPTION OF DRAWINGS

FIG. 1 shows a schematic diagram of a system for managing assets in accordance with one or more embodiments of the invention.

FIG. 2 shows a schematic diagram of information model instances for an asset type in accordance with one or more embodiments of the invention.

FIG. 3 shows a schematic diagram of a data acquisition runtime used for managing assets in accordance with one or more embodiments of the invention.

FIG. 4 shows a schematic diagram of a development repository used for creating definitions to manage assets in accordance with one or more embodiments of the invention.

FIGS. 5A-5B show a flowchart of a method for adding a new computer system in accordance with one or more embodiments of the invention.

FIG. 6 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and apparatus for creating definitions to manage assets. Specifically, the definitions provide a mechanism for managing assets of different asset types through a common interface. Managing an asset includes monitoring the asset, actively managing the asset, registering the asset, or performing any other function on the asset. More specifically, embodiments of the invention use a repository of primitive definitions that may be used to create a new definition for a new asset type. In order to create a new definition, the new definition only needs to inherit from the primitive definitions in the repository. Further, embodiments of the invention create a mechanism for extending and modifying the primitive definitions when defining the new definition.

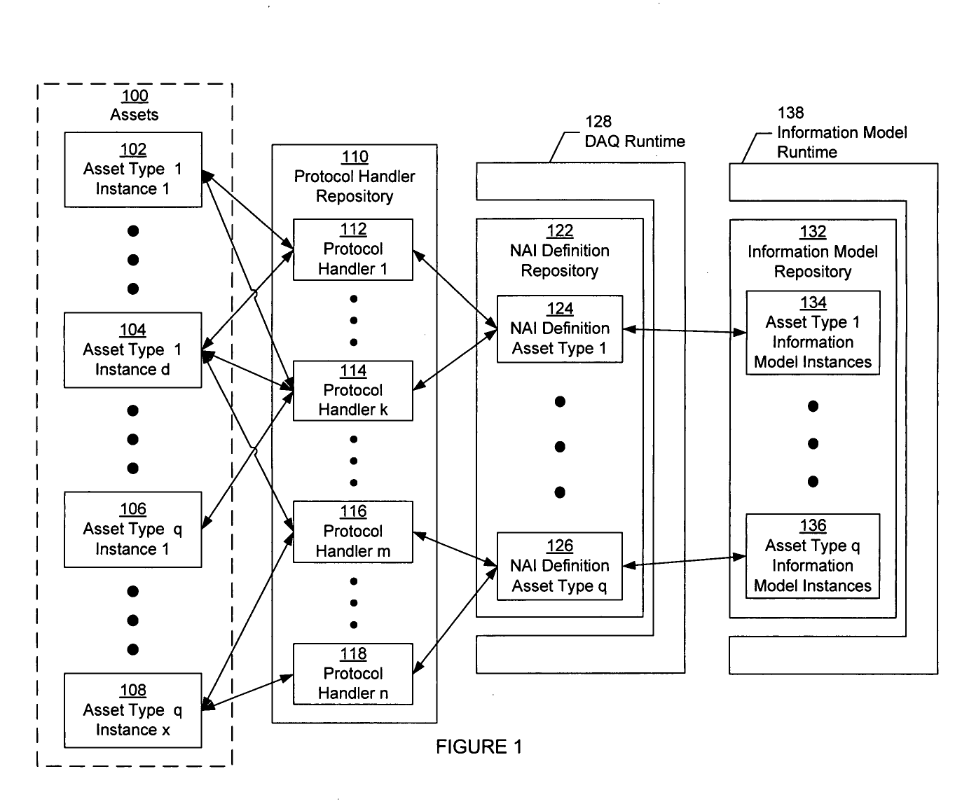

FIG. 1 shows a schematic diagram of a system for managing assets in accordance with one or more embodiments of the invention. As shown in FIG. 1, the system includes assets (100), a protocol handler repository (110), a native asset interface (NAI) definition repository (122), a data acquisition (DAQ) runtime (128), an information model repository (132), and an information model runtime (138) in accordance with one or more embodiments of the invention. Each of these components is described below.

An asset (100) corresponds to any type of actual manageable resource in accordance with one or more embodiments of the invention. Specifically, asset (100) corresponds to the resources that are the object of the management. For example, an asset may correspond to software (e.g., operating system, database application, network application, or any other type of software) or hardware (e.g., computer systems, routers, switches, etc.).

One attribute of an asset (100) corresponds to the asset type. An asset type specifies a group of characteristics of the asset. The asset type may specify a type of operating system, a type of hardware, a type of server, etc. For example, if the asset corresponds to a particular set of hardware and software, then the asset type for the asset may correspond to an identifier for the particular hardware and software. Assets that have the same asset type (i.e., have the same software and hardware) correspond to instances of the asset type in accordance with one or more embodiments of the invention. Specifically, an asset type may have one or more instances (e.g., asset type 1/instance 1 (102), asset type 1/instance d (104), asset type q/instance 1 (106), asset type q/instance x (108)) of the asset type. For example, as shown in FIG. 1, asset type 1 has at least two instances (e.g., asset type 1/instance 1 (102) and asset type 1/instance d (104)), while asset type q has at least two separate instances (e.g., asset type q/instance 1 (106) and asset type q/instance x (108)). Instances of an asset type typically have the same native asset interface (NAI).

An NAI corresponds to a collection of instrumentation and control interfaces that is provided by the asset for the purposes of managing the asset. For example, an NAI may correspond to command line programs, files, simple network management protocol (SNMP), Intelligent Platform Management Interface (IPMI), etc.

Further, each asset type may also have attributes values for categories of the asset type. In one or more embodiments of the invention, the categories of the asset type correspond to identifiers for individual manageable units (e.g., operating system, networking components, software, security system, etc.) for the asset type.

Continuing with FIG. 1, the system also includes a protocol handler repository (110) in accordance with one or more embodiments of the invention. A protocol hander repository (110) corresponds to a storage unit, such as a file system or library, for protocol handlers (e.g., protocol handler 1 (112), protocol handler k (114), protocol handler m (116), protocol handler n (118)). A protocol handler (e.g., protocol handler 1 (112), protocol handler k (114), protocol handler m (116), protocol handler n (118)) corresponds to a logical component that includes functionality to directly access the data, methods, and functions of an asset (100). Specifically, the protocol handler (e.g., protocol handler 1 (112), protocol handler k (114), protocol handler m (116), protocol handler n (118) includes functionality to use the NAI of the asset in order to manage the asset.

In one or more embodiments of the invention, each protocol handler (e.g., protocol handler 1 (112), protocol handler k (114), protocol handler m (116), protocol handler n (118)) is designed for a single protocol or NAI. For example, one protocol handler (e.g., protocol handler 1 (112), protocol handler k (114), protocol handler m (116), protocol handler n (118)) may include functionality to manage assets that use the SNMP, another protocol handler may be designed for IPMI, while another protocol handler may be designed for assets that are managed through Integrated Light Out Management (ILOM) developed by Sun Microsystems, Inc. and another protocol handler may manage assets that use the Network Time Protocol (NTP). In one or more embodiments of the invention, only one protocol handler exists for any single protocol. Those skilled in the art will appreciate that multiple protocol handlers may exist for any single protocol for redundancy purposes.

Because the protocol handlers are associated with a single protocol, each protocol handler (e.g., protocol handler 1 (112), protocol handler k (114), protocol handler m (116), protocol handler n (118)) is connected to one or more asset instance (e.g., asset type 1/instance 1 (102), asset type 1/instance d (104), asset type q/instance 1 (106), asset type q/instance x (108)) in accordance with one or more embodiments of the invention. Specifically, assets (100) that have at least one common NAI are connected to the same protocol handler regardless of whether the assets are of the same asset type.

Similarly, each asset instance (e.g., asset type 1/instance 1 (102), asset type 1/instance d (104), asset type q/instance 1 (106), asset type q/instance x (108)) is connected to one or more protocol handlers (e.g., protocol handler 1 (112), protocol handler k (114), protocol handler m (116), protocol handler n (118)) in accordance with one or more embodiments of the invention. Specifically, each asset instance (e.g., asset type 1/instance 1 (102), asset type 1/instance d (104), asset type q/instance 1 (106), asset type q/instance x (108)) may be accessed by one or more protocol handlers (e.g., protocol handler 1 (112), protocol handler k (114), protocol handler m (116), protocol handler n (118)) that correspond to the protocols for managing the asset.

In addition to the protocol handler repository (110), the system includes a NAI definition repository (122). A NAI definition repository (122) corresponds to a storage unit, such as a library or file system, for NAI definitions (e.g., NAI definition asset type 1 (124), NAI asset type q (126)). An NAI definition (e.g., NAI definition asset type 1 (124), NAI asset type q (126)) corresponds to an abstraction of the management components of an asset in accordance with one or more embodiments of the invention. Specifically, an NAI definition stipulates how data acquisition is performed and how data is populated for access. Moreover, an NAI definition (e.g., NAI definition asset type 1 (124), NAI asset type q (126)) provides a common interface for defining the manageable components of the different assets. In one or more embodiments of the invention, each asset type has a single NAI definition (e.g., NAI definition asset type 1 (124), NAI asset type q (126)). Accordingly, the same NAI asset type definition may be used for multiple asset instances of the same asset type.

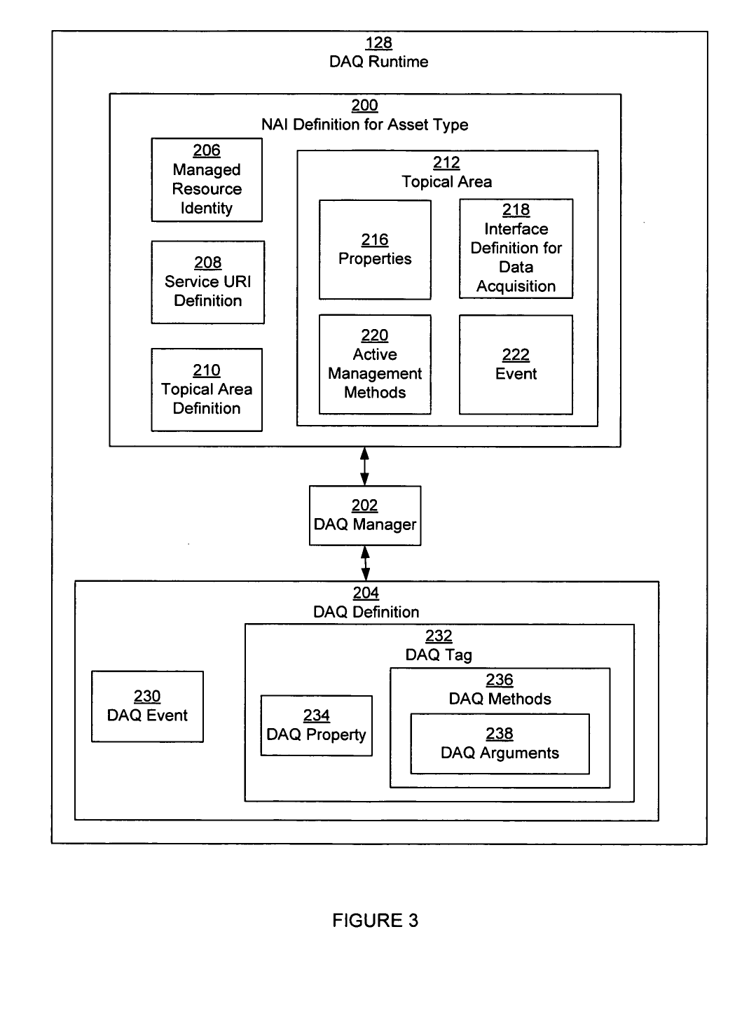

A data acquisition (DAQ) runtime (128) corresponds to a logical component that includes functionality to use a runtime binding of the NAI definition to manage the asset. Moreover, in one or more embodiments of the invention, the DAQ runtime (128) corresponds to the main focus of the system. Specifically, the DAQ runtime includes functionality to operate on NAI definitions (e.g., NAI definition asset type 1 (124), NAI asset type q (126)). The DAQ runtime (128), and the NAI definitions (e.g., NAI definition asset type 1 (124), NAI asset type q (126)) are described in more detail in FIG. 3.

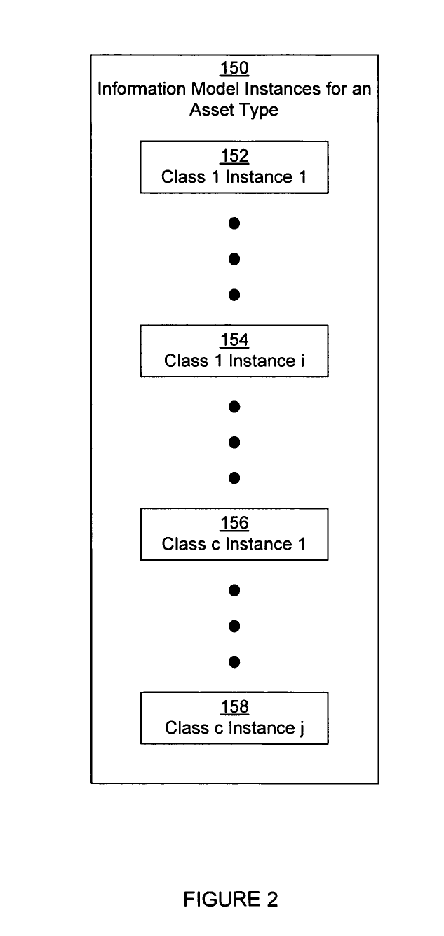

Continuing with FIG. 1, the NAI definitions (e.g., NAI definition asset type 1 (124), NAI asset type q (126)) are connected to an information model that includes the information model repository (132) and the information model runtime (138). An information model corresponds to a public interface for assets (100). The information model repository (132) corresponds to a storage unit for information model instances (e.g., asset type 1 information model instances (134), asset type q information model instances (136)). The information model instances (e.g., asset type 1 information model instances (134), asset type q information model instances (136)) are described in more detail in FIG. 2.

Continuing with the information model repository (132) of FIG. 1, the information model runtime (138) includes functionality to provide an execution environment for the information model repository (132). Specifically, the information model runtime (138) corresponds to the classes and methods of the information model during execution.

FIG. 2 shows a schematic diagram of information model instances for an asset type (150) in accordance with one or more embodiments of the invention. As shown in FIG. 2, each information model for an asset type includes multiple classes. A class corresponds to a collection of methods and properties that are common to a particular kind of component of the asset type. The method corresponds to the methods that can be used for managing an asset. The properties correspond to the manageable variables of an asset. For example, if the asset type is a particular type of server, a class may correspond to properties and methods for managing the operating system component for the particular type of server.

Each class includes multiple class instances (e.g., class 1/instance 1 (152), class 1/instance i (154), class c/instance 1 (156), class c/instance j (158)) in accordance with one or more embodiments of the invention. A class instance (e.g., class 1/instance 1 (152), class 1/instance i (154), class c/instance 1 (156), class c/instance j (158)) corresponds to an abstraction of an asset type instance in information model format. In one or more embodiments of the invention, the information model format corresponds to common information model (CIM) format (developed by Distributed Management Task Force, Inc. located in Portland, Oreg.). As shown in FIG. 2, the class instances (e.g., class 1/instance 1 (152), class 1/instance i (154), class c/instance 1 (156), class c/instance j (158)) for the information model may not be in a one to one relationship with the instances of the asset type for the class. In particular, some asset type instances may not have a corresponding instance for a particular information model class.

Each information model class instance (e.g., class 1/instance 1 (152), class 1/instance i (154), class c/instance 1 (156), class c/instance j (158)) is connected to a mapping specification (not shown) in accordance with one or more embodiments of the invention. The mapping specification includes functionality to map between the information model format and the DAQ format of the DAQ runtime. Accordingly, an information model class instance (e.g., class 1/instance 1 (152), class 1/instance i (154), class c/instance 1 (156), class c/instance j (158)) can manage virtually any asset without knowledge of the specific protocols used to manage the asset.

Alternatively, in one or more embodiments of the invention, each information model class instance (e.g., class 1/instance 1 (152), class 1/instance (154), class c/instance 1 (156), class c/instance j (158)) may include the information required to format communication in the DAQ format in order to directly communicate with the DAQ runtime in accordance with one or more embodiments of the invention.

FIG. 3 shows a schematic diagram of a DAQ runtime (128) used for managing assets in accordance with one or more embodiments of the invention. As shown in FIG. 3, the DAQ runtime (128) includes an NAI definition for the asset type (200), a DAQ manager (202) and a DAQ definition (204) in accordance with one or more embodiments of the invention. Each of these components is described below.

An NAI definition for an asset type (200) corresponds to a description of the NAI for the asset. Specifically, for each manageable component of the asset type, the NAI definition defines how to manage the component using the NAI of the component. In one or more embodiments of the invention, the NAI definition includes a scheme or protocol (e.g., SNMP, IPMI, etc.), and a part that defines how to execute the NAI in context of the protocol. For example, suppose that information about a computer system are gathered by a command line command “uname-a.” Then the NAI definition may specify that the protocol is a shell, the location of the computer system, and the command “uname-a.”

Further, in one or more embodiments of the invention, an NAI definition for the asset type (200) corresponds to a complex type. Specifically, in one or more embodiments of the invention, the NAI definition may inherit from primitive definitions (described below). Accordingly, a reference to the primitive definition may be included in the NAI definition.

In one or more embodiments of the invention, the NAI definition for the asset type (200) is defined using extensible markup language (XML). Specifically, the aforementioned components of the NAI definition are denoted by XML tags. Moreover, in one or more embodiments of the invention, the NAI definition complies with a predefined XML schema. The NAI definition for the asset type (200) includes a managed resource identity (206), a service URI definition (208), a topical area definition (210), and a topical area (212). Each of these components is described below.

The managed resource identity (206) corresponds to a definition of the asset type. Specifically, the managed resource identity (206) uniquely identifies the asset type in the NAI repository (not shown). In one or more embodiments of the invention, the managed resource identity (206) corresponds to an alpha-numeric identifier.

In addition to the managed resource identity (206), the NAI definition for the asset type (200) includes a service URI definition (208). The service URI definition (208) denotes how instances of the asset are enumerated. Specifically, the service URI definition (208) defines the scheme and method for identifying all instances of the asset type. For example, the service URI definition (208) may specify an enumeration service, a database, a discovery protocol, or any other mechanism for enumerating instances of an asset type.

The NAI definition for the asset type (200) also includes a topical area definition (210) in accordance with one or more embodiments of the invention. A topical area definition (210) identifies the different topical areas that can be managed for an asset type. For example, if the asset type is a computer system, then the topical area definition (210) may specify that the different manageable components of the asset type or topical areas of the asset type. For example, the topical areas may correspond to operating system, storage, networking, executing processes, or other such area.

In accordance with one or more embodiments of the invention, each topical area includes a topical area definition (212). The topical area definition (212) corresponds to a specification for managing the topical area. The topical area definition (212) includes properties (216), interface definitions for data acquisition (218), active management methods (220), and events (222). Each of these components is described below.

Properties (216) correspond to the information in the topical area about the asset type. Specifically, a property (216) corresponds to the information and data that can be set and obtained from an asset. For example, if the topical area corresponds to storage, then the properties may correspond to storage space, partitioning, amount of used space, etc. In one or more embodiments of the invention, the name of a property is unique within the namespace of the topical area. Further, in one or more embodiments of the invention, each property (216) includes a plurality of attributes. For example, the attributes of the property (216) may correspond to the name, a description, whether the property is able to be changed, the data type of values of the property, etc.

The interface definition for data acquisition (218) identifies how the properties (216) are populated in accordance with one or more embodiments of the invention. Specifically, the interface definition for data acquisition (218) specifies the scheme and method in the context of the scheme that is used to manage the asset in relation to the property. For example, the interface definition for data acquisition may correspond to snmp://target@host:port/1.3.6.2.1.1.1.*. The SNMP portion shows the scheme that is used to obtain a property as required by the NAI for the property is SNMP. The remainder portion of the example interface definition corresponds to the location for obtaining and setting the property on the asset.

Continuing with FIG. 3, the topical area definition (212) also includes active management methods (220). The active management methods (220) correspond to information about the methods that the NAI for the asset type provides in order to manage the asset by modification. For example, a method from the NAI may correspond to reset a particular value. The active management methods (220) identify how the value is reset. In one or more embodiment of the invention, active management methods (220) provide information for invoking the method for the NAI of the asset type.

Another component of the topical area definition (212) is an event (222). An event (222) corresponds to information for subscribing for notifications. Specifically, the NAI for the asset type generally includes mechanisms for receiving periodic notifications or only notification of changes. An event (222) corresponds to the definition of how to turn on the NAI for the notifications. For example, an event (222) may correspond to information about how to register for information about temperature.

In addition to the NAI definition for the asset type (200), the DAQ runtime (128) includes a DAQ definition (204) in accordance with one or more embodiments of the invention. A DAQ definition (204) corresponds to a runtime image of the NAI definition for the asset type (200). Specifically, the DAQ definition (204) corresponds to a runtime binding of the NAI definition for the asset type (200). For example, whereas in one or more embodiments of the invention, the NAI definition for the asset type (200) is in XML language, the DAQ definition (204) may correspond to an object oriented programming language.

More specifically, a binding compiler (not shown) includes functionality to translate XML schema into one or more Java™ classes without requiring the developer to write complex parsing code. Further, a binding compiler includes functionality to parse through the NAI definition (204) and replace references to a primitive definition (described below with a copy of the primitive definition object).

In addition, in one or more embodiments of the invention, each DAQ definition (204) has the same names for the methods regardless of the different NAI definitions. Accordingly, the DAQ definition provides a common interface for each of the different asset types of the NAI definitions.

In one or more embodiments of the invention, the DAQ definition (204) includes a DAQ event (230) and a DAQ tag (232). A DAQ event (230) corresponds to a runtime binding of an event (222). Specifically, a DAQ event (230) includes functionality to compare an old value and new value for a property corresponding to the DAQ event (230). Further, the DAQ event includes functionality to register listeners for the DAQ event (230) and inform registered listeners of a current status (e.g., changes between the old and new value, no change, etc.) of the property associated with the DAQ event (230).

A DAQ tag (232) corresponds to a runtime image of the topical area definition (212). Accordingly, those skilled in the art will appreciate that a DAQ tag (232) exists for each topical area definition (212) in accordance with one or more embodiments of the invention. The DAQ tag (232) includes a DAQ property (234) and DAQ methods (236).

A DAQ property (234) corresponds to a runtime image of the properties definition (216). Similarly, DAQ methods (236) correspond to a runtime image of the active management methods (220). The DAQ methods (236) include DAQ arguments (238). The DAQ arguments (238) correspond to the arguments required by the NAI methods of the asset. For example, if the NAI method for an asset corresponding to storage is to change the partitioning of the storage, then the DAQ arguments for a DAQ method of partitioning may specify how the storage devised is partitioned.

Interposed between the DAQ definition (204) and the NAI definition for an asset type (200) is a DAQ manager (202). The DAQ manager (202) corresponds to a logical engine that includes functionality to perform a runtime binding of the NAI definition for the asset type (200) with the DAQ definition (204) in accordance with one or more embodiments of the invention. Further, the DAQ manager (202) includes functionality to identify the DAQ definition (204) for a given management request and trigger the operations required using the DAQ definition (204) for managing the asset according to the management request.

For example, in one exemplary implementation of one or more embodiments of the invention, the DAQ runtime includes functionality to process request of type get attributes, set attributes, invoke methods, and manage event subscription requests. The DAQ runtime processing of the requests in the exemplary implementation is described below.

In one or more embodiments of the invention, in response to a get attribute request the runtime includes functionality to perform the following. Specifically, in response to the get attribute request, the runtime includes functionality to determine the DAQ tag where the attribute of interest is located by accessing the DAQ definition associated with the asset. The DAQ definition can be located via the assets NAI specification document, which is bound at execution time into the DAQ definition object. Next, the runtime includes functionality to obtain from the DAQ definition object the URI associated with the DAQ tag in accordance with one or more embodiments of the invention. Specifically, the DAQ tag includes the URI definition for the obtaining value of the attribute from the NAI of the asset in accordance with one or more embodiments of the invention. After obtaining the necessary information for identifying the NAI for the asset, the runtime includes functionality to query the protocol handler repository to obtain the protocol handler that corresponds to the URI associated with the DAQ tag in accordance with one or more embodiments of the invention. Finally, the runtime includes functionality to perform an invocation of the protocol handler to obtain the value of the required attribute.

Continuing with the example, in one or more embodiments of the invention, in response to a set attribute request the runtime includes functionality to perform the following. Specifically, in response to the set attribute request, the DAQ runtime includes functionality to determine the location of the DAQ tag for setting the attribute of interest. Determining the location may be performed by accessing the DAQ definition object associated with the asset in accordance with one or more embodiments of the invention. Next, the DAQ runtime includes functionality to obtain the URI associated with the DAQ tag from the DAQ definition object for the attribute in accordance with one or more embodiments of the invention. After obtaining the necessary information to set the attribute, the DAQ runtime includes functionality to query the protocol handler repository to obtain the protocol handler that corresponds to the URI associated with the DAQ tag in accordance with one or more embodiments of the invention. Finally, the DAQ runtime performs invocations of the protocol handler found in the library to set the attribute with the requested value.

Continuing with the example, in one or more embodiments of the invention, in response to an invoke method request the runtime includes functionality to perform the following. Specifically, in response to the invoke method request, the DAQ runtime includes functionality to determine the DAQ tag where the method of interest is located by accessing the DAQ definition associated with the asset. After determining the DAQ tag, the DAQ runtime includes functionality to obtain the URI associated with the method to be invoked from the DAQ definition object in accordance with one or more embodiments of the invention. Once the necessary information to invoke the method is obtained, the DAQ runtime includes functionality to query the protocol handler repository to obtain the protocol handler that corresponds to the URI associated with the DAQ tag in accordance with one or more embodiments of the invention. Finally, the DAQ runtime includes functionality to perform a method invocation operation on the protocol handler that executes the API for the method to be invoked.

Lastly, in the example implementation, when the DAQ runtime receives an event subscription request, the DAQ runtime includes functionality to determine the DAQ tag for the subscription event of interest is located by accessing the DAQ definition associated with the asset. After determining the DAQ tag, the DAQ runtime includes functionality to obtain the URI associated with the DAQ tag from the DAQ definition object in accordance with one or more embodiments of the invention. Once the necessary information to invoke the method is obtained, the DAQ runtime includes functionality to query the protocol handler repository to obtain the protocol handler that corresponds to the URI associated with the DAQ tag in accordance with one or more embodiments of the invention. Finally, the DAQ runtime includes functionality to perform a subscription request operation using the protocol handler to obtain notification of events through the NAI of the asset.

As shown in the above example, the common interface through the DAQ allows for an information model to perform virtually any management functions on the asset that are exposed through the NAI of the asset without having the NAI of the asset in accordance with one or more embodiments of the invention. Specifically, using the aforementioned requests, virtually any management operation can be performed in accordance with one or more embodiments of the invention.

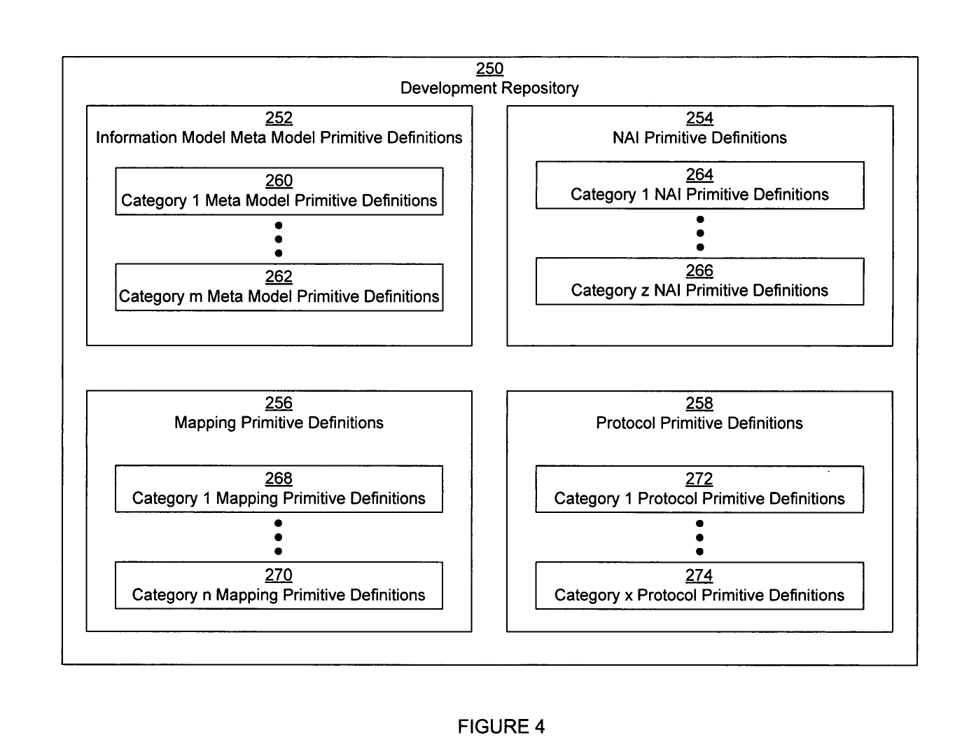

Before a management request for an asset can be processed, the definitions for the asset type are created from a set of primitive definitions. FIG. 4 shows a schematic diagram of a development repository used for creating definitions to manage assets in accordance with one or more embodiments of the invention. A development repository (250) corresponds to a storage unit for primitive definitions. The development repository (250) may exist virtually anywhere in the system (described in FIG. 1). The development repository (250) may even span multiple components of the system. For example, components of the development (250) repository may be divided across the information model, the DAQ runtime, the protocol handler repository, etc. As shown in FIG. 4, the development repository (150) includes information model meta model primitive definitions (252), NAI primitive definitions (254), mapping primitive definitions (256), and protocol primitive definitions (258). Each of these components is described below.

In general, a primitive definition (e.g., information model meta model primitive definitions (252), NAI primitive definitions (254), mapping primitive definitions (256), and protocol primitive definitions (258)) correspond to a collection of definitions that can be used through concepts of object oriented programming, such as inheritance, to create a new definition for a new asset type. Those skilled in the art will appreciate that the primitive definitions may be a part of a pre-existing library or developed when asset types are added to the system. For example, a primitive definition corresponds to a definition used for an existing asset type of the system.

The information model primitive definitions (252) correspond to a collection of definitions for the information model. Specifically, the information model primitive definitions (252) may be used to create the classes for a new asset type in the information model (described above). In one or more embodiments of the invention, the information model primitive definitions are divided into categories (e.g., category 1 meta model primitive definitions (260), category m meta model primitive definitions (262)). The categories of the primitive definitions (e.g., category 1 meta model primitive definitions (260), category m meta model primitive definitions (262)) correspond to the categories of the manageable components for an asset type (described above) in one or more embodiments of the invention. For example, category 1 meta model primitive definitions (260) may correspond to the primitive definitions for software management of the operating systems, while category m meta model primitive definitions (262) may correspond to primitive definitions for managing hardware for a variety of networking components. Further, while not shown, each category of primitive definitions may be subdivided into specific attribute values for the category. For example, operating system primitive definitions may be divided into version and vendors.

The NAI primitive definitions (254) correspond to a collection of definitions to populate the NAI repository. Specifically, the NAI primitive definitions (254) may be used to create the NAI definition for a new asset type in the DAQ runtime (described above). Each NAI primitive definition is in XML in one or more embodiments of the invention. Thus, a single definition may be found within two XML tags. Further, in one or more embodiments of the invention, each NAI primitive definition follows the naming convention of <asset_type>.<topic_tag_name>.properties. By using the naming convention, each component of the primitive definition may be specified in a new definition. In one or more embodiments of the invention, the NAI primitive definitions are divided into categories (e.g., category 1 NAI primitive definitions (264), category z NAI primitive definitions (266)). As shown in FIG. 4, the number of categories for the NAI primitive definitions (254) may or may not be equal to the number of categories for the information model meta model primitive definitions (252).

The mapping primitive definitions (256) correspond to a collection of definitions to populate the mapping specification. Specifically, the mapping primitive definitions (256) may include a set of primitive definitions for mapping between the information model and the DAQ runtime (described above). In one or more embodiments of the invention, the mapping primitive definitions (256) are divided into categories (e.g., category 1 mapping primitive definitions (268), category n NAI primitive definitions (270)). Each category of primitive definition may correspond to a topic tag in a DAQ definition, a class in the information model, a category of the asset type, etc. in accordance with one or more embodiments of the invention.

The protocol primitive definitions (258) correspond to a collection of definitions to populate the protocol handler repository. Specifically, the protocol primitive definitions (258) may include a set of primitive definitions for creating a specific protocol handler (described above). In one or more embodiments of the invention, the protocol primitive definitions (258) are divided into categories (e.g., category 1 protocol primitive definitions (272), category x protocol primitive definitions (274)). Each category of protocol primitive definition may correspond to a type of protocol handler in accordance with one or more embodiments of the invention.

In one exemplary implementation, a new definition for an asset type may be defined using key words. Specifically, a binding compiler (described above) may include functionality to interpret the key word to determine how to inherit from a primitive definition. In an exemplary implementation, the word “extends” is used to indicate the name of the primitive definition to inherit. For example, “extends” followed by an asset type name, topic tag name, and/or property name may be used to indicate that the new definition is to inherit from the asset type, topic tag, and/or property from which to inherit. Further, a key word for specific methods, properties, or events, such as “C” for create, “R” to retrieve, “U” for override, and “D” for delete may be used to specify how to inherit from a primitive definition. Specifically, the key indicator may be used to specify what to inherit for a particular method, property, and/or event. For example, using the above key indicators to inherit from a primitive definition for a topic tag, “C” may be use to specify that the definition of the method, property, and/or event after the “C” is new and not in the primitive definition, “R” may be use to specify that the definition of the method, property, and/or event after the “R” should be inherited directly from the primitive definition, “U” may be use to specify that the definition of the method, property, and/or event after the “U” is to override the definition found in the primitive definition, and “D” may be use to specify that the definition of the method, property, and/or event after the “D” should not be included in the new definition.

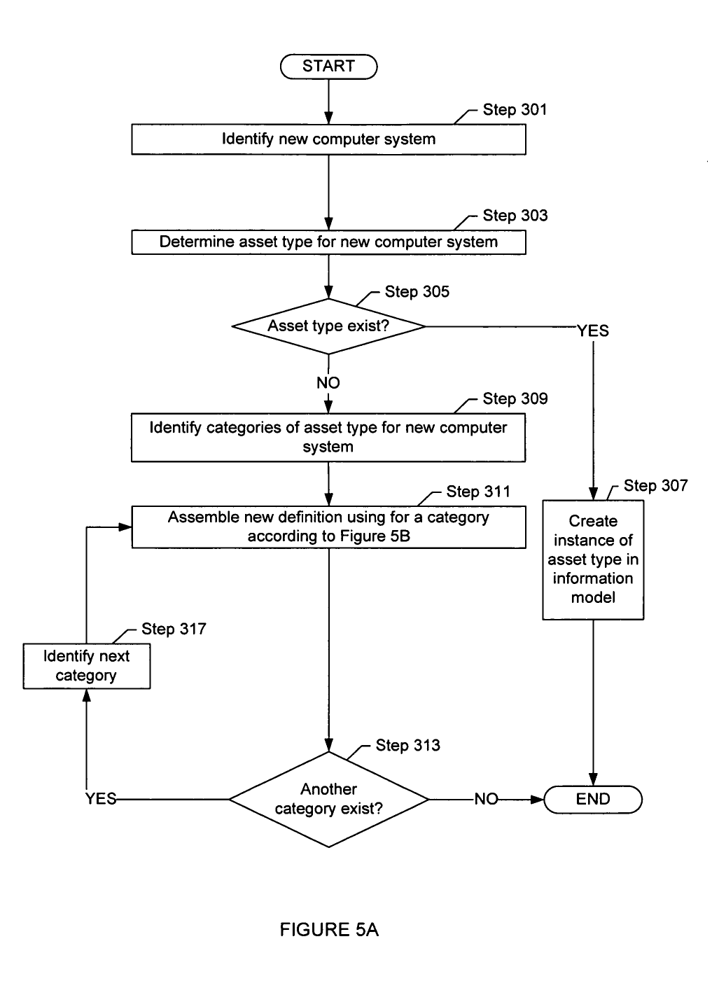

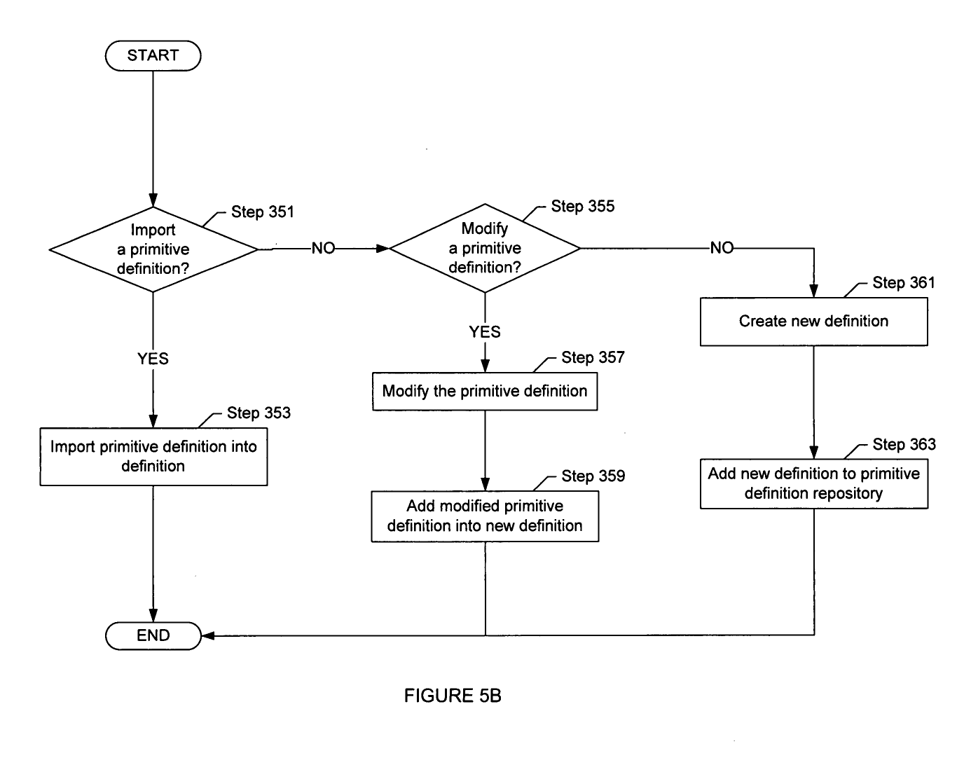

Using the primitive definitions, new definitions for a computer system may be easily added to the system. FIGS. 5A-5B show a flowchart of a method for adding a new computer system in accordance with one or more embodiments of the invention. Specifically, in one or more embodiments of the invention, the flowchart shown in FIG. 5A and FIG. 5B may be used for adding a new definition to the protocol handler repository, mapping specification, information model, NAI definition repository, etc.

Starting with FIG. 5A, initially, a new computer system is identified (Step 301). Specifically, an administrator may specify that the new computer system is added to the system or a discovery mechanism may find the new computer system. Next, the asset type for the new computer system is identified (Step 303). The asset type may be identified by receiving the information from an administrator, accessing a knowledge base, searching information embedded in the computer systems, identifying the components of the new computer system to check whether the components match an asset type previously existing, etc.

Once the asset type is identified, a determination is made whether the asset type that is identified matched an existing asset type (Step 305). Specifically, if the identified asset type is already defined, then new definitions do not need to be created in accordance with one or more embodiments of the invention. Accordingly, an instance of the asset type is created in the information model (Step 307). Also, at this stage, information regarding finding the instance of the asset type may be added to the DAQ runtime in accordance with one or more embodiments of the invention.

Alternatively, if the asset type is not already in the system, then the categories of the asset type are identified for the new computer system (Step 309). Specifically, the manageable components of the new computer system are identified. Identifying the categories may be performed, for example, by accessing a knowledge base for the categories.

Next, a definition is assembled for a category using FIG. 5B (Step 311). The definition may be assembled for a particular topical area in accordance with one or more embodiments of the invention. Specifically, the definition may be assembled by creating an entirely new definition, importing from an existing definition, etc.

Once the definition is assembled, a determination is made whether another category exists (Step 313). If another category exists, then the next category is identified (Step 315) and the method repeats in accordance with one or more embodiments of the invention. Alternatively, the newly created definition may be added to the repository.

FIG. 5B shows a flowchart of a method for assembling a definition in accordance with one or more embodiments of the invention. Initially, a determination is made whether to import the primitive definition directly into the new definition (Step 351). A primitive definition may be imported directly if the NAI of the asset type for the category is the same as the NAI of a primitive definition in the development repository. If a primitive definition can be imported directly, then the primitive definition is imported into the new definition (Step 353). In order to import the primitive definition, an identifier (e.g., a name) of the primitive definition is found. At this stage, a developer may specify with a key word identifier, such as “extends” with the identifier of the primitive definition to indicate that a specific primitive definition is to be imported into the new definition. At runtime or compile time, the binding compiler may add a copy of the primitive definition when performing the binding to the DAQ definition in accordance with one or more embodiments of the invention.

Alternatively, if the primitive definition is not to be imported, then a determination is made whether the primitive definition should be modified (Step 355). Specifically, the primitive definition may be extended by adding a new property, method, event, or class.

Accordingly, if modifying the primitive definition, then a primitive definition is modified (Step 357). At this stage, a component of the asset type may be identified that has a different NAI than the primitive definition. For example, if the asset type has mostly the same networking components as specified by the primitive definition with the exception of the NAI for enabling or disabling a connection, then the primitive definition may be imported with the specification using a key word that the method for enabling/disabling the connected is to be overwritten with a new definition. As shown in the aforementioned example, individual components of the primitive definition may be added, removed, or overwritten for a particular asset type.

Once the primitive definition is modified, then the primitive definition is added into the new definition (Step 359). Specifically, at runtime or compile time, the binding compiler may add a copy of the primitive definition with the modifications when performing the binding to the DAQ definition in accordance with one or more embodiments of the invention.

Alternatively, if the primitive definition is not to be modified, then the new definition is most likely to be created for the category. Accordingly, a new definition is created (Step 361). At this stage, the developer may access a knowledge base for the category and the asset type to determine the NAI for the category. For example, if the new definition is an NAI definition, then the developer may use a schema for the NAI repository and the NAI accessed to create the new definition. Once the new definition is created for the category, then the new definition may be added to the primitive definition repository for the category (Step 363) in accordance with one or more embodiments of the invention. Thus, the new definition can be reused.

Once the definitions for each category for the new computer system are created, then the new computer system can be managed using the DAQ runtime. In general, managing the new computer system may be performed in one or more embodiments of the invention by processing a management request as discussed below.

Initially, a management request is received from a management application. Typically, the management request is received by an information model class instance according to an asset type specified by the management request. By accessing the information model class instance, an API is called from the information model class instance. In one or more embodiments of the invention, the call to the API is intercepted and the DAQ definition is identified using the mapping specification. Once the DAQ definition is identified, the request is translated from the information model format to the data acquisition format using the mapping specification. Next, the protocol handler is triggered based on the DAQ definition. Specifically, as previously stated, the DAQ definition identifies the protocol handlers and the mechanism for managing the asset using the protocol handlers. Based on the DAQ definition, the protocol handler is triggered with the information about the mechanism for the management.

Accordingly an asset instance is invoked using the protocol handler. Specifically, the protocol handler uses the NAI that is identified by the NAI definition to invoke the management of the asset instance by the asset. By invoking the asset instance, the asset is managed and results may be acquired and transmitted back to the management application.

In the following example, consider the case in which the development repository includes sensor meta-data definitions for the IPMI protocol, network hardware meta-data definitions for the IPMI protocol, sensor meta-data definitions for the Advanced Lights Out Manager (ALOM) protocol developed by Sun Microsystems, Inc., network hardware meta-data definitions for the ALOM protocol, software management meta-data definitions for the Solaris™ Operating System (O.S.) developed by Sun Microsystems, Inc. (a trademark of Sun Microsystems, Inc. located in Santa Clara, Calif.), network management meta-data definitions for the Solaris™ O.S., software management meta-data definitions for Redhat Linux® O.S. developed by Red Hat, Inc. (a registered trademark of Red Hat, Inc. located in Raleigh, N.C.), network management meta-data definitions for the Redhat Linux® O.S., software management meta-data definitions for the Windows® XP O.S. developed by Microsoft Corporation (a registered trademark of the Microsoft Corporation located in Redmond, Wash.), network management meta-data definitions for the Windows® XP O.S., and network interface meta-data definitions for the Management Information Base (MIB) II SNMP protocol.

Further, consider the case in which a developer wants to develop the agentry required to manage a new computer system that has components created by Intel, Corp. and uses the Solaris™ O.S. In such scenario, in one or more embodiments of the invention, the developer can obtain from the development repository that is populated as discussed above, the following definitions: sensor meta-data definitions for the IPMI protocol, network hardware meta-data definitions for the IPMI protocol, software management meta-data definitions for the Solaris™ O.S., network management meta-data definitions for the Solaris™ O.S., and the network interface meta-data definitions for the MIB II SNMP protocol.

Specifically, when defining the NAI definition, in one or more embodiments of the invention, the developer includes the statement:
Asset-type: ‘new computer system’,
   Import: sensor.IPMI
   Import: network-hardware.IPMI
   Import: software-management.Solaris
   Import: network-management.Solaris
   Import: network-interface.SNMP-MIBII

In the scenario in which the definition is accurate and there are no property, methods, or event changes, additions or overrides, then the NAI definition does not require addition definition in accordance with one or more embodiments of the invention. Accordingly, during runtime, the ‘import’ statements trigger an expansion of the meta-data document associated. Thus, the DAQ definition appears as if the imported definitions were expressly included in the NAI definition.

In the scenario, in the example, in which changes must be performed, then ‘extends’ may be added to topic-tags, properties, methods, definitions of the NAI definition in accordance with one or more embodiments of the invention. For example, in the ‘software-management.Solaris’ definition, the properties of the topical area for sw-pkgs may add the name, install-date, version, and vendor. Using key indicators (e.g., “C”, “R”, “U”, and “D”) as attribute values in an XML based NAI definition, the new properties in the sw-pkgs may be easily added, overwritten, deleted, or created without having to create the entire NAI definition from scratch.

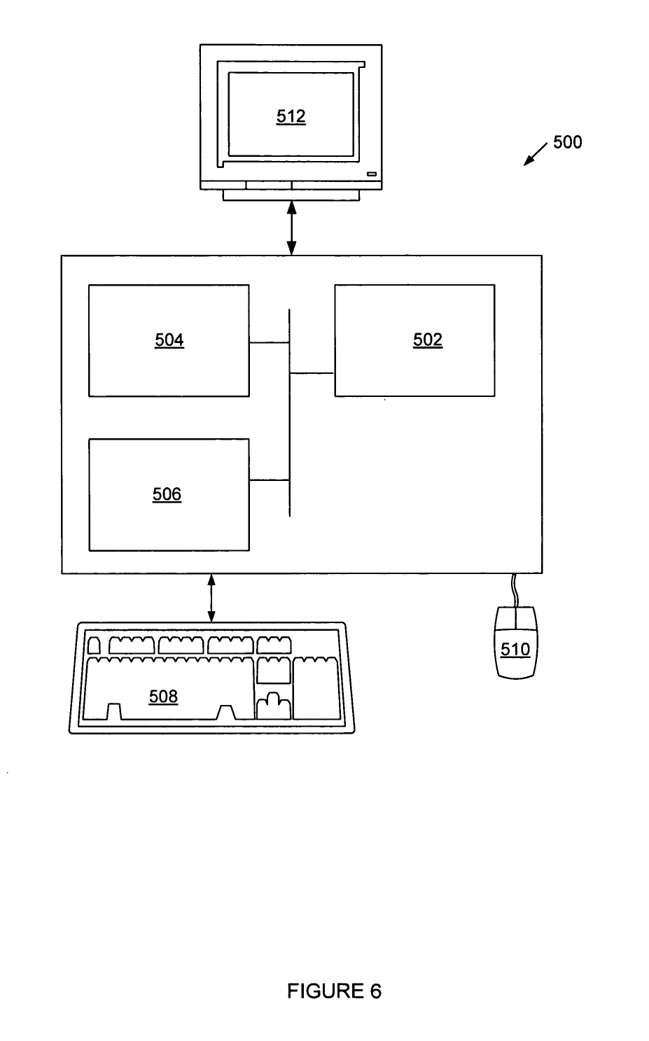

The invention may be implemented on virtually any type of computer regardless of the platform being used. For example, as shown in FIG. 6, a computer system (500) includes a processor (502), associated memory (504), a storage device (506), and numerous other elements and functionalities typical of today's computers (not shown). The computer (500) may also include input means, such as a keyboard (508) and a mouse (510), and output means, such as a monitor (512). The computer system (500) is connected to a local area network (LAN) or a wide area network (e.g., the Internet) (not shown) via a network interface connection (not shown). Those skilled in the art will appreciate that these input and output means may take other forms.

Further, those skilled in the art will appreciate that one or more elements of the aforementioned computer system (500) may be located at a remote location and connected to the other elements over a network. Further, the invention may be implemented on a distributed system having a plurality of nodes, where each portion of the invention (e.g., NAI definition, DAQ definition, Information model repository, protocol handler repository, etc.) may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

Embodiments of the invention provide a mechanism for easy management of assets. Specifically, embodiments of the invention minimize the amount of framework code required for managing an asset. For example, by only adding metadata definitions to the DAQ runtime in the form of NAI definitions, new assets of new asset types can be easily added to the system. Specifically, when new assets are added to the system, the information model may only be adjusted to add class information for managing the new asset. The specific protocol information for the new asset and NAI specific methods for managing the asset do not need to be added to the information model.

Moreover, by developing a repository that includes primitive definitions, the addition of a new asset type only requires importing the correct primitive definitions and performing any necessary modifications. Thus, rather than expressly defining all manageable components in a definition of a new asset type, a developer, for example, can take advantage of existing primitive definitions. Moreover, when a primitive definition requires modification, the modification only needs to be performed once. On reloading of the definitions that use the primitive definitions, the modification will be propagated to the reloaded definitions in accordance with one or more embodiments of the invention.

Therefore, embodiments of the invention take advantage of object-oriented programming to leverage existing instrumentation definitions and reduce the amount of re-work needed to be performed. Accordingly, embodiments of the invention reduce the barrier of entry for new products to be instrumented and integrated into systems and network management framework.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for managing an asset comprising:
identifying an asset type of the asset;
identifying a plurality of categories of the asset type;
assembling a plurality of primitive definitions into a native asset interface definition according to the plurality of categories, wherein the plurality of primitive definitions are stored in a library, wherein the native asset interface definition is bound to a data acquisition (DAQ) definition, and wherein the DAQ definition is an interface between a protocol handler and an information model; and
adding the native asset interface definition to a DAQ runtime, wherein the DAQ runtime uses the DAQ definition to manage the asset.

2. The method of claim 1, wherein assembling the plurality of primitive definitions comprises for each category of the plurality of categories:
importing a primitive definition of the plurality of primitive definitions from the library to the native asset interface definition, wherein importing is based on the category.

3. The method of claim 2, wherein importing the primitive definition comprises:
identifying a component of the primitive definition;
modifying the component of the primitive definition to obtain a modified component; and
saving the modified component and a reference to the primitive definition in the native asset interface definition.

4. The method of claim 3, wherein modifying the component of the primitive definition comprises:
indicating the removal of the component in the native asset interface definition.

5. The method of claim 3, wherein modifying the component of the primitive definition comprises
overriding the component in the native asset interface definition.

6. The method of claim 2, wherein importing a primitive definition comprises:
adding a component to the primitive definition to obtain an added component; and
saving the added component and a reference to the primitive definition in the native asset interface definition.

7. The method of claim 2, wherein the component is one selected from the group consisting of a native asset interface method, a property, and an event.

8. The method of claim 2, wherein modifying the component comprises adding an attribute to the component.

9. The method of claim 1, wherein the native asset interface definition is in extensible markup language.

10. The method of claim 1, further comprising:
adding a primitive definition of the plurality of primitive definitions to the library.

11. A system for managing an asset comprising:
a library for storing a plurality of primitive definitions; and
a developer environment for:
identifying an asset type of the asset;
identifying a plurality of categories of the asset type;
assembling a plurality of primitive definitions into a native asset interface definition according to the plurality of categories, wherein the plurality of primitive definitions are stored in a library, wherein the native asset interface definition is bound to a data acquisition (DAQ) definition, and wherein the DAQ definition is an interface between a protocol handler and an information model; and
adding the native asset interface definition to a DAQ runtime, wherein the DAQ runtime uses the DAQ definition to manage the asset.

12. The system of claim 11, wherein assembling the plurality of primitive definitions comprises for each category of the plurality of categories:
importing a primitive definition of the plurality of primitive definitions from the library to the native asset interface definition, wherein importing is based on the category.

13. The system of claim 12, wherein importing the primitive definition comprises:
identifying a component of the primitive definition; and
modifying the component of the primitive definition to obtain a modified component;
saving the modified component and a reference to the primitive definition in the native asset interface definition.

14. The system of claim 13, wherein modifying the component of the primitive definition comprises:
indicating the removal of the component in the native asset interface definition.

15. The system of claim 13, wherein modifying the component of the primitive definition comprises:
overriding the component in the native asset interface definition.

16. The system of claim 12, wherein importing a primitive definition comprises:
adding a component to the primitive definition to obtain an added component; and
saving the added component and a reference to the primitive definition in the native asset interface definition.

17. The system of claim 12, wherein the component is one selected from the group consisting of a native asset interface system, a property, and an event.

18. The system of claim 12, wherein modifying the component comprises adding an attribute to the component.

19. The system of claim 11, wherein the native asset interface definition is in extensible markup language.

20. A computer usable medium comprising computer readable program code embodied therein for causing a computer system to:
identify an asset type of an asset;
identify a plurality of categories of the asset type;
assemble a plurality of primitive definitions into a native asset interface definition according to the plurality of categories, wherein the plurality of primitive definitions are stored in a library, wherein the native asset interface definition is bound to a data acquisition (DAQ) definition, and wherein the DAQ definition is an interface between a protocol handler and an information model; and
add the native asset interface definition to a DAQ runtime, wherein the DAQ runtime uses the DAQ definition to manage the asset.
